(19) United States
(12) Patent Application Publication
(10) Pub. No.: US 2003/0136434 A1
(43) Pub. Date: Jul. 24, 2003

(54) Kit for emptying and cleaning household electric steam generator

(75) Inventors: Christian Giovalle, Moidieu Detourbe (FR); Dominique Gelus, Eyzin (FR)

Correspondence Address: BROWDY AND NEIMARK, P.L.L.C., 624 NINTH STREET, NW, SUITE 300, WASHINGTON, DC, 20001-5303, US

(73) Assignee: SEB S.A., Ecully (FR)

(21) Appl. No.: 10/349,030

(22) Filed: Jan. 23, 2003

(30) Foreign Application Priority Data
Jan. 24, 2002 (FR) 02 00842

(51) Int. Cl. B08B 3/00

(52) U.S. Cl. 134/166 R; 134/198

(57) ABSTRACT

A device for cleaning a water tank of a steam generator for a household electric appliance, the device being composed of: a lance for delivering a stream of water into the tank, the lance being connectable to a source of water under pressure; and a tubular body associated with the lance for evacuating water from the tank. The device is configured to be introduced into the tank via an accessible opening of the tank, and to be connected to the accessible opening.

### BACKGROUND OF THE INVENTION

The present invention relates to household electric steam generators having a vaporization tank for boiling water that is contained therein.

Such a generator is found, for example, in ironing appliances, tools for stripping wallpaper, etc.

In these generators, in which the entire mass of water is brought to boiling, precipitated minerals, known as fur, are deposited on the walls of the tank in the form of sediment that can harden into scale. When the quantity of sediment becomes substantial, it takes the form of foam under the action of the steam bubbles and can then be conveyed, by a mechanism known as primage, into the appliance that is supplied by the generator, causing undesired effects. In the case of a clothes-ironing appliance, for example, the entrained minerals can block an electrical control valve or can be deposited on the articles being ironed so as to leave very disagreeable marks.

The sediment that accumulates in the tank should thus be evacuated periodically in order to avoid these drawbacks. For example, it is recommended to perform a cleaning operation at three-month intervals for a clothes-pressing appliance that has normal use. The cleaning operation consists in draining the tank before it has become empty. The sediment is then carried along with the water being drained. The draining can take place by turning the appliance upside down so that the water is drained through the filling opening, which then also serves for draining, or, if the tank is so provided, through an orifice specially provided for draining.

However, such draining only correctly evacuates minerals that are in suspension in the water; sediment that has been deposited on the bottom of the tank or against its walls is not easily removed. In order to achieve a more complete evacuation, it is necessary to agitate the tank. Since the tank is generally not separable from the appliance, it is thus necessary to agitate the entire appliance, which is frequently not convenient. It is often necessary to rinse the tank by a further refilling and draining. However, these tedious operations are only undertaken reluctantly by the users and are carried out in a less than perfect manner. In addition, water carrying the sediment escapes in an uncontrolled manner from the appliance as a result of the agitation and thus can wet and soil visible walls of the appliance, which then requires a further cleaning of the appliance.

### BRIEF SUMMARY OF THE INVENTION

The present invention serves to overcome these drawbacks by greatly facilitating the cleaning of the tank of a household electric steam generator, avoiding having to shake the appliance, while systematically causing the rinsing of the tank to be done in an effective, clean and simple manner.

For this purpose, the invention provides a device, or kit, for cleaning the tank of the steam generator for a household electric appliance which is noteworthy in that the kit includes a lance for delivering water, the lance being connected to a source of water under pressure and associated with a tubular body for evacuation of the water, this device being intended to be introduced into and connected to an accessible opening of the tank.

When the tank is not provided with a separate opening that is specifically intended for draining, the filling orifice is used instead as the accessible opening.

The lance device causes water to be delivered at high speed into the tank, assuring an agitation that detaches the soft sediment from the walls and the bottom of the tank. It is not necessary to complete the action of the water by agitating the appliance, which can be placed above or in proximity to a receptacle or drain for the water that is withdrawn.

The evacuation body controls the outflow of the water carrying the sediment. Uncontrolled spattering and smudging are avoided.

Because the lance and the tubular water evacuation body are connected together, introduction of the device into the accessible opening is simplified. The user does not have to independently direct the lance. The device can be simply adjusted to the opening or screwed in in place of the usual closing stopper. The water is evacuated to the environment without creating any significant pressure increase within the tank. Thus, the connection of the device to the opening does not require perfect sealing means.

Preferably, the lance is disposed at the interior of the tubular water evacuation body.

The lance has a smaller cross section than the accessible opening in the tank. Since the accessible opening into which the lance is introduced is normally a relatively large draining or filling opening, it is not necessary to modify existing tanks in order to provide them with a special opening for the cleaning device.

Preferably, the lance is connected to a faucet that supplies water under pressure through a flexible tube provided with a quick-connect connector or an elastomeric fitting for connection to the faucet.

It is only necessary for the user to push the fitting onto the outlet end of the faucet. Since the tubing will remain under low pressure, a universal type of fitting will prove satisfactory. A wide range of suitable fittings or other connectors are known from the patent literature and commercial products. The fitting is advantageously similar to those used, for example, to connect a faucet to a small clothes washing machine that is manually controlled.

Preferably, the passages in the tubular evacuation body and the lance are of circular cross section, the longitudinal axis of the lance being, at least locally at it outlet end, parallel to the longitudinal axis of the evacuation body and being offset to be above the longitudinal axis of the evacuation body when the device is in its cleaning position.

The arrangement allows the possible evacuation of clumps and larger particles of the minerals than if the axis of the lance were coaxial with that of the tubular evacuation body.

Preferably, the tubular evacuation body has a passage that includes a bend.

The outflow of rinsing water can then be in a vertical downward direction, above a suitable water collection receptacle or drain, while the axis of the accessible opening of the tank can be horizontal, or can have any other orientation, during the cleaning.

According to an improved embodiment, the lance has a nozzle that directs the water jet obliquely with respect to the longitudinal axis of the lance. The jet can be directed in an oblique direction onto the internal wall of the tank in order to thus better collect sediment that is adhering thereto.

According to another form of construction, the lance has a nozzle that divides the water jet into several directed jets in order to strike different zones at the interior of the tank.

### BRIEF DESCRIPTION OF THE DRAWING

FIG. 1 is a simplified, elevational view, partly and cross section, showing a cleaning device according to the invention connected to a tank and faucet for performing a cleaning operation.

FIG. 2 is a cross-sectional detail view of the lance and evacuation body of a device according to the invention.

### DETAILED DESCRIPTION OF THE INVENTION

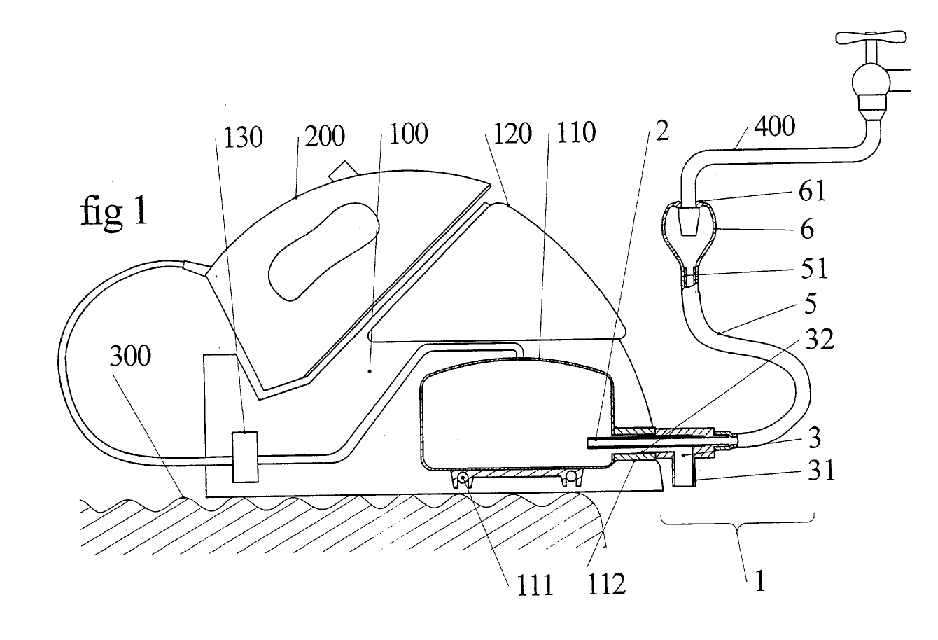

FIG. 1 shows a preferred embodiment of a device according to the invention connected between a clothes pressing appliance and a water supply faucet 400. The clothes pressing appliance includes a steam generator 100 and a pressing iron 200. Steam generator 100 includes a vaporization tank 110 and a reservoir 120 connected to supply water to tank 110, if necessary with the aid of a pump (not shown). Steam generated in tank 110 is supplied via tubing and an electrically controlled valve 130 to pressing iron 200. Tank 110 is associated with a heating element 111 and includes an accessible opening 112 that is reinforced by a casing and that can normally be closed by a plug or threaded stopper (not shown).

When tank 110 is to be cleaned, the appliance is placed on a receptacle or in a sink 300 so that water carrying the minerals can flow through opening 112 and into the receptacle or the sink drain. A cleaning device 1 according to the invention is screwed into opening 112 in place of the plug or stopper that is normally provided and bears against the casing that reinforces opening 112.

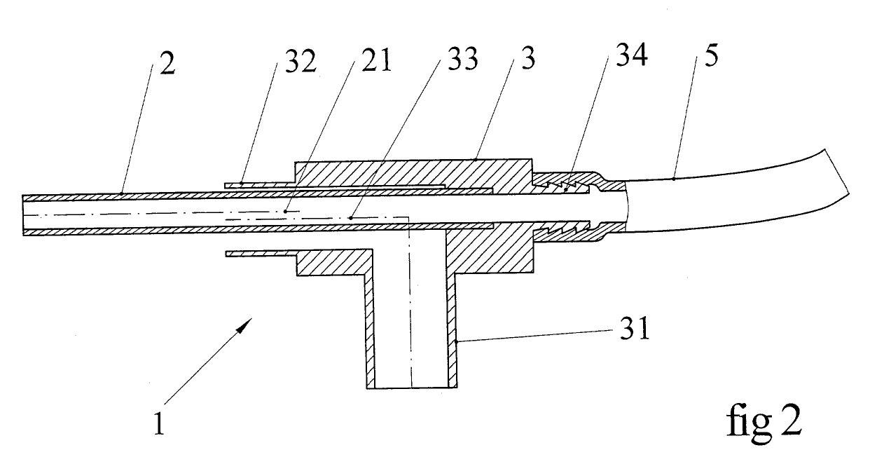

Device 1 is shown in greater detail in FIG. 2 and is composed of a water delivery lance 2 that will project into tank 110, as shown in FIG. 1, when device 1 is installed in opening 112. Lance 2 is fixed at the interior of the bent evacuation passage provided in a tubular body 3. One end 32 of body 3 is screwed or otherwise attached to opening 112 of tank 110 and the other end 31 of body 3 is opened to the environment above the drain of sink 300. Lance 2 is preferably constituted by a cylindrical tube-or pipe having an outer diameter that is smaller than the inner diameter of the passage formed in tubular body 3, and both lance 2 and the inner diameter of the passage formed in tubular body 3 can be of circular cross section. Lance 2 is fixed in body 3 in line with a protruding coupling piece 34. In the vicinity of the opening 112, the longitudinal axis 21 of lance 2 is parallel to the longitudinal axis 33 of the part of the evacuation passage that is located at end 32 of body 3. However, axis 21 is offset above axis 33 to leave a space in the evacuation passage in body 3 below lance 2 for the flow of large particles out of tank 110. Piece 34 is provided to connect lance 2 to a faucet 400 of the type that is available in all homes, via a flexible tube 5 and a flexible attachment piece 61, preferably made of elastomer and having an elastic inlet opening 61 that can be fitted to virtually any type of faucet simply by pushing a connecting piece 6, which may have a bulbous form, over the outlet end of faucet 400.

Connecting piece 6 is connected to flexible tube 5 by a connecting element 51, which may have a tapered form. Thus, connecting piece 6 can easily be replaced with any other type of connecting piece that the user may require.

Threaded end 32 of body 3 can be adapted to other appliances and other modes of attachment corresponding to the manner of attachment of the plug or stopper normally used on the tank with which the device is to used. The connection between the drain opening of tank 110 and body 3 need not form a tight vapor or water seal since the outlet end 31 of the evacuation passage in body 3 is substantially at atmospheric pressure when the device is in use.

Outlet end 31 of tubular body 3 can be extended by an evacuation pipe or tube within which a low pressure, or even a pressure below atmospheric, is established.

The outlet end of lance 2 can have a nozzle adapted to obtain increased water outlet velocities and/or direction different from the direction of axis 21.

When the user wants to clean out tank 110, he places the appliance, for example, in sink 300, or on another suitable surface with the drain opening of tank 110 above the sink drain. The stopper of the drain opening is removed and replaced with tubular body 3 of device 1, without requiring a tight fit with the accessible opening since a high pressure seal is not necessary. Connecting piece 6 is then placed over the outlet end of faucet 400 and the faucet is turned on. Water flows at high velocity and low pressure from faucet 400 via connecting piece 6, tubing 5 and lance 2 into the interior of tank 110. The water flows turbulently into tank 110, lifting and separating the mineral deposits from the walls of tank 110, so that the mineral deposits are entrained in the water and evacuated with the water through the evacuation passage defined by tubular body 3. The water with entrained minerals fails vertically from outlet end 31 into the drain of sink 300.

At the start of the operation, the water is heavily loaded with mineral materials and flows with a gray color. Eventually, the large particles of mineral materials are detached from the walls of tank 110 and transported by the water. When substantially all of the mineral materials have been removed from tank 110, the water exiting from tubular body 3 becomes clear. At that time, the user can turn off faucet 400 and disconnect piece 6 from faucet 400. Residual water contained in tube 5 flows through outlet end 31 of body 3. When all flow has halted, the user can remove body 3 from accessible opening 112 and reinstall the usual stopper or plug. The operation is then terminated and the appliance is ready for further use.

It is thus apparent that the cleaning kit according to the invention greatly facilitates maintenance of such appliances.

This application relates to subject matter disclosed in French Application Number FR 02-00842, filed on Jan. 24, 2002, the disclosure of which is incorporated herein by reference.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A device for cleaning a water tank of a steam generator for a household electric appliance, said device comprising:
a lance for delivering a stream of water into the tank, said lance being connectable to a source of water under pressure; and
a tubular body associated with said lance for evacuating water from the tank,
wherein said device is configured to be introduced into the tank via an accessible opening of the tank, and to be connected to the accessible opening.

2. The device of claim 1, wherein said lance is disposed within said tubular body.

3. The device of claim 1, further comprising a flexible tube coupled to said lance and provided with a connector or fitting for connecting said lance to a faucet that supplies water under pressure.

4. The device of claim 1, wherein said lance and said tubular body each have a passage of circular cross section and a longitudinal axis, and the longitudinal axis of said lance is, at least locally at the outlet end of said lance, parallel to, and above, the longitudinal axis of said tubular body when said device is in the accessible opening in a position for cleaning the tank.

5. The device of claim 1, wherein said tubular body has a water flow passage that has a bend.

6. The device of claim 1, wherein said lance has a longitudinal axis and comprises a nozzle at its outlet end that directs a water stream obliquely with respect to the longitudinal axis of said lance.

7. The device of claim 1, wherein said lance has a nozzle that divides water from said lance into several directed streams in order to strike different zones at the interior of the tank.
